(19) United States
(12) Patent Application Publication
(10) Pub. No.: US 2014/0172439 A1
(43) Pub. Date: Jun. 19, 2014

(54) ORGANIZED HEALTHCARE FRAUD DETECTION

(71) Applicant: VERIZON PATENT AND LICENSING INC., Basking Ridge, NJ (US)

(72) Inventors: Adrian E. CONWAY, Weston, MA (US); James H. DREW, Sugar Hill, NH (US)

(73) Assignee: VERIZON PATENT AND LICENSING INC., Basking Ridge, NJ (US)

(21) Appl. No.: 13/720,324

(22) Filed: Dec. 19, 2012

(51) Int. Cl. G06F 19/00

(52) U.S. Cl. CPC G06F 19/328
USPC 705/2

(57) ABSTRACT

A fraud detection system receives information that identifies healthcare claims associated with providers and beneficiaries, and determines, based on the healthcare claims, first fraud sets associated with postulated classes of fraud. The fraud detection system determines, based on the healthcare claims, second fraud sets using one or more data mining techniques, and calculates probabilities that the first fraud sets and the second fraud sets are similar to no fraud observations. The fraud detection system ranks the first fraud sets and the second fraud sets based on the calculated probabilities, and outputs a ranked list of suspected fraud cases, associated with the healthcare claims, based on the ranking of the first fraud sets and the second fraud sets.

### BACKGROUND

Healthcare fraud is a sizeable and significant challenge for the healthcare and insurance industries, and costs these industries billions of dollars each year. Healthcare fraud is a significant threat to most healthcare programs, such as government sponsored programs and private programs. Currently, healthcare providers, such as doctors, pharmacies, hospitals, etc., provide healthcare services to beneficiaries, and submit healthcare claims for the provision of such services. The healthcare claims are provided to a clearinghouse that makes minor edits to the claims, and provides the edited claims to a claims processor. The claims processor, in turn, processes, edits, and/or pays the healthcare claims. The clearinghouse and/or the claims processor may be associated with one or more private or public health insurers and/or other healthcare entities.

After paying the healthcare claims, the claims processor forwards the paid claims to a zone program integrity contractor. The zone program integrity contractor reviews the paid claims to determine whether any of the paid claims are fraudulent. A recovery audit contractor may also review the paid claims to determine whether any of them are fraudulent. In one example, the paid claims may be reviewed against a black list of suspect healthcare providers. If the zone program integrity contractor or the recovery audit contractor discovers a fraudulent healthcare claim, they may attempt to recover the monies paid for the fraudulent healthcare claim. However, such methods are typically unsuccessful since an entity committing the fraud may be difficult to detect.

### BRIEF DESCRIPTION OF THE DRAWINGS

FIG. 1 is a diagram of an overview of an example implementation described herein;

FIG. 2 is a diagram of an example environment in which systems and/or methods, described herein, may be implemented;

FIG. 3 is a diagram of example components of a device that may be used within the environment of FIG. 2;

FIG. 4 is a diagram of example interactions between components of an example portion of the environment depicted in FIG. 2;

FIG. 5 is a diagram of example functional components of a fraud detection system of FIG. 2;

FIG. 6 is a diagram of example functional components of a fraud analysis component of FIG. 5;

FIG. 7 are diagrams of example fraud scenarios that may be detected by the fraud detection system;

FIG. 8 is a diagram of example state labeling and state transitions in a claims model created by a claims modeling component of FIG. 6;

FIG. 9 is a diagram of example modified and unmodified transition probabilities in the claims model of FIG. 8;

FIG. 10 is a diagram of example functional components of a collusion analysis component of FIG. 6; and

FIGS. 11 and 12 are flowcharts of an example process for detecting organized healthcare fraud.

### DETAILED DESCRIPTION OF PREFERRED EMBODIMENTS

The following detailed description refers to the accompanying drawings. The same reference numbers in different drawings may identify the same or similar elements.

Systems and/or methods, described herein, may detect organized fraud in healthcare claims billing data. The systems and/or methods may detect organized healthcare fraud based on an assumption that it is highly improbable that a specific set of beneficiaries (e.g., patients) visit a same specific set of providers. The improbability may increase as a number of the beneficiaries and/or the providers increases and/or as geographic separation between the beneficiaries and the providers increases. The systems and/or methods may detect such unlikely scenarios in a set of claims, and may determine that the unlikely scenarios are a result of organized fraud. For example, if three or more beneficiaries, located in a first location (e.g., a first zip code), use a single provider located in a second remote location (e.g., a second zip code remote from the first zip code), the systems and/or methods may determine that this represents organized healthcare fraud. The systems and/or methods may determine that the beneficiaries know each other and are receiving kickbacks, and that the provider is using the beneficiaries' names to fraudulently bill. This scenario may be even more fraudulent if three or more beneficiaries, located in two or more different locations, use two or more providers located in different remote locations.

In one example implementation, the systems and/or methods described herein may determine that, over a period of time, each beneficiary in a set of claims will visit various providers according to a Markov chain model. The systems and/or methods may determine that each beneficiary may be characterized by a trajectory that is an ordered list of providers visited and is a row in a trajectory matrix T(p). The providers visited by any given beneficiary may be located at varying geographic distances from one another, and the systems and/or methods may utilize a gravity model, either theoretical or empirical, to determine a probability that a beneficiary from one zip code will visit a provider in another zip code. The gravity model may identify a number of beneficiary visits from one zip code to another zip code that may be expected in a normal course of events without fraud.

The systems and/or methods may identify providers with frequent patient visits using an affinity analysis data mining technique. The systems and/or methods may identify providers associated with remote visits, and may test the identified providers for conformity to the gravity model via a fraudhood ratio test. The fraudhood ratio test may provide a ranking of the most non-conforming provider associations and a threshold for what is significant non-conformance. The identified providers may constitute sets of suspicious providers.

From the set of suspicious providers, the systems and/or methods may use results from the affinity analysis to test and rank high frequency associations between each provider in the set of suspicious providers and any other providers, regardless of their remoteness. This testing and ranking may produce a set of potential colluders (e.g., one set for each provider in the set of suspicious providers) that may constitute a collection of potential rings of colluders.

Although the systems and/or methods are described herein in connection with healthcare fraud, in other implementations, the systems and/or methods may be utilized to detect a wide variety of other types of organized fraud, such as phishing, bank fraud, investment fraud, credit card fraud, etc.

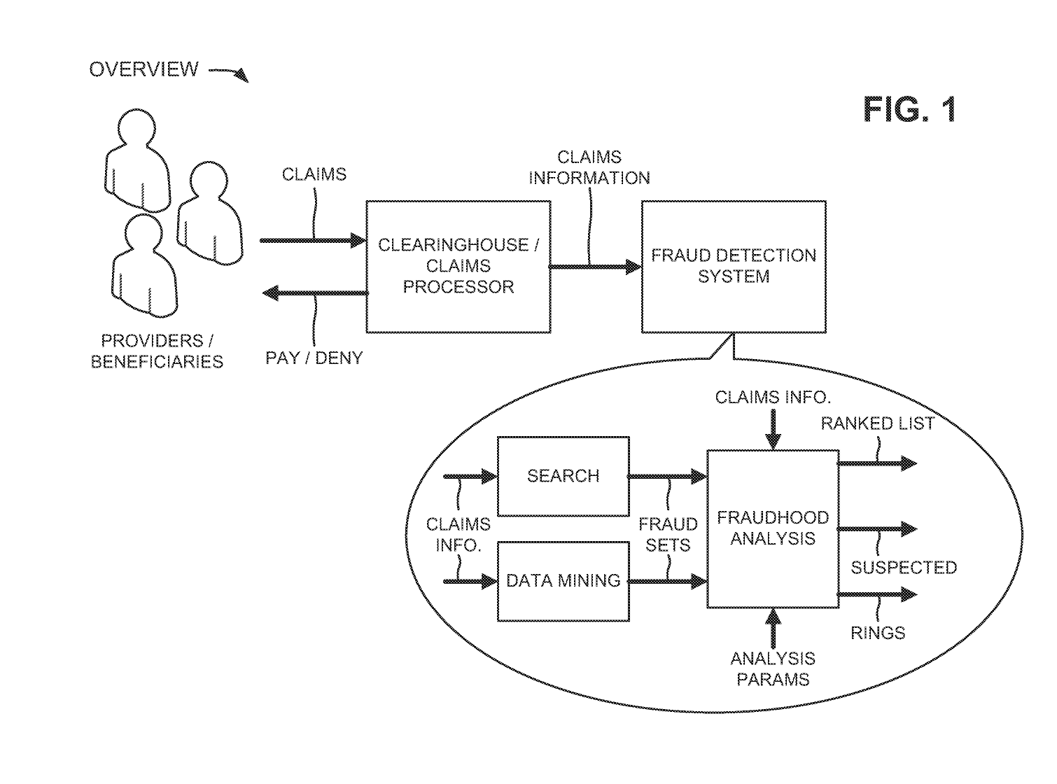

FIG. 1 is a diagram of an overview of an example implementation described herein. For the example of FIG. 1, assume that beneficiaries receive healthcare services from a provider, such as a prescription provider, a physician provider, an institutional provider, a medical equipment provider, etc. The term “beneficiary,” as used herein, is intended to be broadly interpreted to include a member, a person, a business, an organization, or some other type of entity that receives healthcare services, such as prescription drugs, surgical procedures, doctor's office visits, physicals, hospital care, medical equipment, etc. from a provider. The term “provider,” as used herein, is intended to be broadly interpreted to include a prescription provider (e.g., a drug store, a pharmaceutical company, an online pharmacy, a brick and mortar pharmacy, etc.), a physician provider (e.g., a doctor, a surgeon, a physical therapist, a nurse, a nurse assistant, etc.), an institutional provider (e.g., a hospital, a medical emergency center, a surgery center, a trauma center, a clinic, etc.), a medical equipment provider (e.g., a diagnostic equipment provider, a therapeutic equipment provider, a life support equipment provider, a medical monitor provider, a medical laboratory equipment provider, a home health agency, etc.), etc.

After providing the healthcare services, the provider may submit claims to a clearinghouse/claims processor system. The terms “claim” or “healthcare claim,” as used herein, are intended to be broadly interpreted to include an interaction of a provider with a clearinghouse, a claims processor, or another entity responsible for paying for a beneficiary's healthcare or medical expenses, or a portion thereof. The interaction may involve the payment of money, a promise for a future payment of money, the deposit of money into an account, or the removal of money from an account. The term “money,” as used herein, is intended to be broadly interpreted to include anything that can be accepted as payment for goods or services, such as currency, coupons, credit cards, debit cards, gift cards, and funds held in a financial account (e.g., a checking account, a money market account, a savings account, a stock account, a mutual fund account, a paypal account, etc.).

The clearinghouse/claims processor system may make minor changes to the claims, and may provide information associated with the claims, such as provider information, beneficiary information, healthcare service information, etc., to a fraud detection system. Alternatively, or additionally, the clearinghouse/claims processor system may pay or deny the claims. If a particular claim is paid, the clearinghouse/claims processor system may provide money to the provider who submitted the particular claim. If a particular claim is denied, the clearinghouse/claims processor system may provide an indication of the denial to the provider who submitted the particular claim. The clearinghouse/claims processor system may be associated with one or more private or public health insurers and/or other healthcare entities. After paying the claims, the clearinghouse/claims processor system may forward the paid claims to a zone program integrity contractor.

As further shown in FIG. 1, the fraud detection system may include a search component, a data mining component, and a fraudhood analysis component. The search component may receive the claims information from the clearinghouse/claims processor system, and may process the claims information to produce first fraud sets that may be members of postulated classes of organized healthcare fraud. A fraud set may include a set of claims that, taken together, may be of possible interest in detecting organized healthcare fraud. A postulated class may include a postulated set of criteria that, if met by a set of claims taken together, may be indicative of possible organized healthcare fraud. The postulated classes may be provided as an input to the search component. The search component may provide the first fraud sets to the fraudhood analysis component.

The data mining component may receive the claims information, and may perform data mining techniques on the claims information to produce second fraud sets from the claims information. The data mining component may provide the second fraud sets to the fraudhood analysis component. Each of the first and second fraud sets may include a set of claims. Alternatively, or additionally, each of the first and second fraud sets may include a derivative fraud set. A derivative fraud set may include a set of beneficiary state trajectories, where a beneficiary state trajectory may include, for example, an ordered sequence of providers that may be visited by a beneficiary over a particular time period.

The fraudhood analysis component may receive the first and second fraud sets, and may receive the claims information and analysis parameters. The analysis parameters may include one or more parameters to be used by the fraudhood analysis component on the first and second fraud sets. In one example, the fraudhood analysis component may calculate observations without fraud (or “no fraud” observations) using a gravitational model of aggregate numbers and loci associated with the claims information. The fraudhood analysis component may calculate probabilities that the first and second fraud sets are statistically the same as the no fraud observations. The fraudhood analysis component may rank the first and second fraud sets based on the calculated probabilities. In one example, the fraudhood analysis component may provide a higher rank to a fraud set with a lower probability of being non-fraudulent than another fraud set with a higher probability of being non-fraudulent.

The fraudhood analysis component may output (e.g., provide for display) a ranked list of suspected fraud cases based on the ranking of the first and second fraud sets. Alternatively, or additionally, the fraudhood analysis component may output (e.g., provide for display) all of the suspected fraud cases found in the first and second fraud sets. The fraudhood analysis component may set thresholds for the calculated probabilities based on either an ability to investigate fraud or on a specified low probability of non-fraudulence. The fraudhood analysis component may identify rings of fraudulent providers based on the thresholds set by the fraudhood analysis component and on the fraudulent providers' frequent associations with other fraudulent providers. The fraudhood analysis component may output (e.g., provide for display) the rings of fraudulent providers.

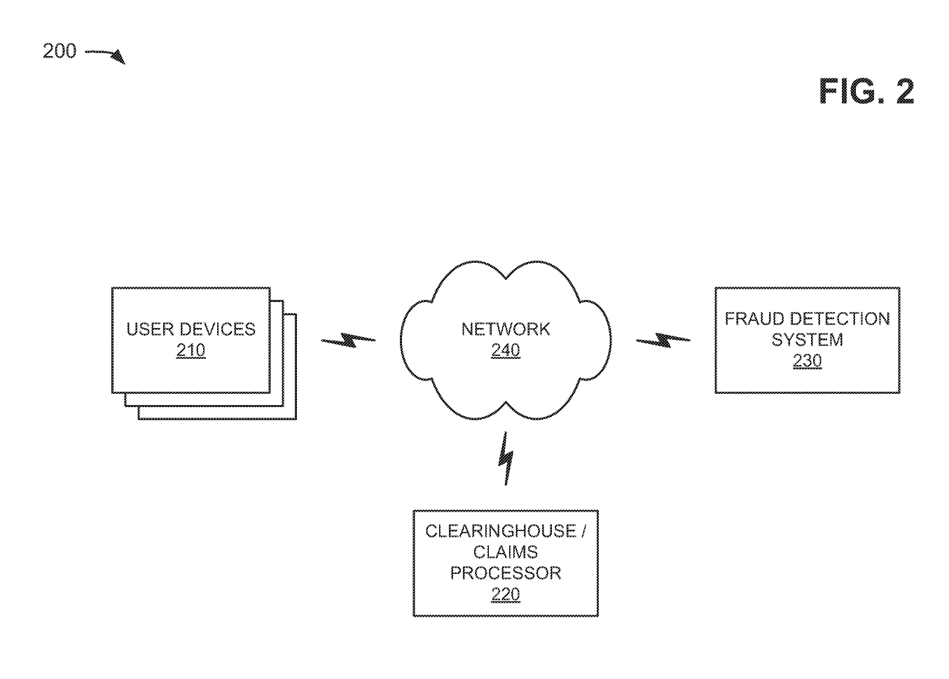

FIG. 2 is a diagram that illustrates an example environment 200 in which systems and/or methods, described herein, may be implemented. As shown in FIG. 2, environment 200 may include one or more user devices 210, a clearinghouse/claims processor system 220, a fraud detection system 230, and a network 240. Components of environment 200 may interconnect via wired and/or wireless connections.

User device 210 may include a device, or a collection of devices, capable of interacting with clearinghouse/claims processor system 220 to submit a healthcare claim associated with healthcare services provided to a beneficiary by a provider. For example, user device 210 may include a communication device (e.g., a mobile phone, a smartphone, a personal digital assistant (PDA), a wireline telephone, etc.), a computer device (e.g., a laptop computer, a tablet computer, a personal computer, etc.), a gaming device, a set top box, or another type of communication or computation device. As described herein, a provider may utilize user device 210 to submit a healthcare claim to clearinghouse/claims processor system 220.

Clearinghouse/claims processor system 220 may include a device, or a collection of devices, that receives healthcare claims from a provider, via one of user devices 210, makes minor edits to the claims, and provides the edited claims to fraud detection system 230. In one example, clearinghouse/claims processor system 220 may receive a healthcare claim from one of user devices 210, and may check the claim for minor errors, such as incorrect beneficiary information, incorrect insurance information, etc. Once the claim is checked and no minor errors are discovered, or once any discovered errors are corrected, clearinghouse/claims processor system 220 may securely transmit the claim to fraud detection system 230.

If a claim is not fraudulent, clearinghouse/claims processor system 220 may process, edit, and/or pay the claim. However, if a claim is suspected to be fraudulent, clearinghouse/claims processor system 220 may deny the claim and may perform a detailed review of the claim. The detailed analysis of the claim by clearinghouse/claims processor system 220 may be further supported by reports and other supporting documentation provided by fraud detection system 230. In one example, clearinghouse/claims processor system 220 may be associated with one or more private or public health insurers and/or other healthcare entities.

Fraud detection system 230 may include a device, or a collection of devices, that performs fraud analysis on healthcare claims. Fraud detection system 230 may receive claims information from clearinghouse/claims processor system 220, may receive other healthcare information from other sources, may perform a fraud analysis with regard to the claims information and in light of the other information and claim types, and may provide, to clearinghouse/claims processor system 220, information regarding the results of the fraud analysis.

In one example implementation, fraud detection system 230 may detect organized fraud in the healthcare claims based on an assumption that it is highly improbable that a specific set of beneficiaries (e.g., patients) visit a same specific set of providers. The improbability may increase as a number of the beneficiaries and/or the providers increases and/or as geographic separation between the beneficiaries and the providers increases. The fraud detection system 230 may detect such unlikely scenarios in a set of claims, and may determine that the unlikely scenarios are a result of organized fraud.

Network 240 may include any type of network or a combination of networks. For example, network 240 may include a local area network (LAN), a wide area network (WAN) (e.g., the Internet), a metropolitan area network (MAN), an ad hoc network, a telephone network (e.g., a Public Switched Telephone Network (PSTN), a cellular network, or a voice-over-IP (VoIP) network), an optical network (e.g., a fiber optic network), or a combination of these or other types of networks. In one implementation, network 240 may support secure communications between user devices 210, clearinghouse/claims processor system 220, and/or fraud detection system 230. These secure communications may include encrypted communications, communications via a private network (e.g., a virtual private network (VPN) or a private IP VPN (PIP VPN)), other forms of secure communications, or a combination of secure types of communications.

Although FIG. 2 shows example components of environment 200, in other implementations, environment 200 may include fewer components, different components, differently arranged components, and/or additional components than those depicted in FIG. 2. Alternatively, or additionally, one or more components of environment 200 may perform one or more other tasks described as being performed by one or more other components of environment 200.

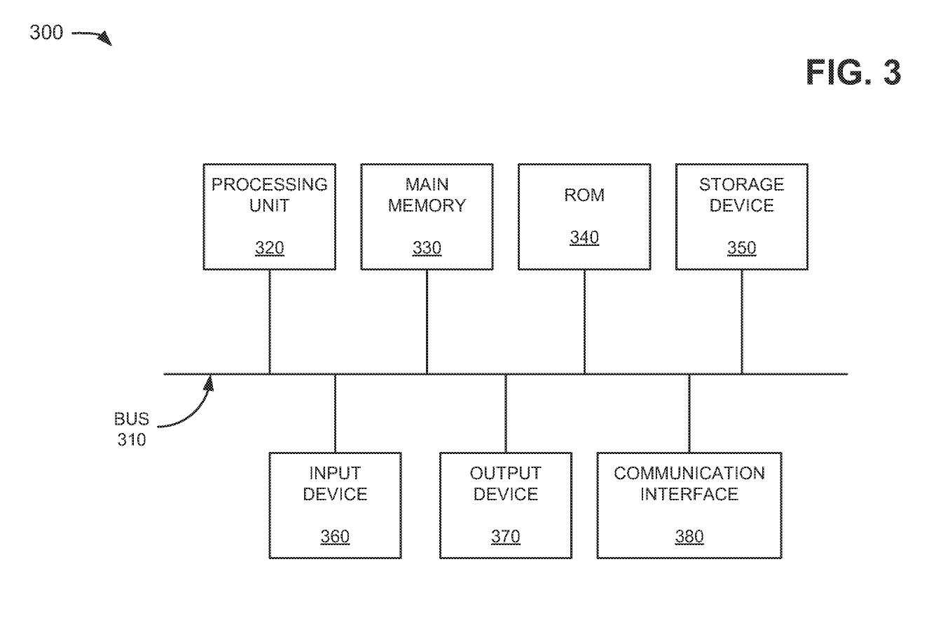

FIG. 3 is a diagram of example components of a device 300. Device 300 may correspond to user device 210, clearinghouse/claims processor system 220, and/or fraud detection system 230. Each of user device 210, clearinghouse/claims processor system 220, and fraud detection system 230 may include one or more devices 300 and/or one or more components of device 300. As shown in FIG. 3, device 300 may include a bus 310, a processing unit 320, a main memory 330, a read only memory (ROM) 340, a storage device 350, an input device 360, an output device 370, and a communication interface 380.

Bus 310 may include a path that permits communication among the components of device 300. Processing unit 320 may include one or more processors, one or more microprocessors, one or more application specific integrated circuits (ASICs), one or more field programmable gate arrays (FPGAs), or one or more other types of processors that interpret and execute instructions. Main memory 330 may include a random access memory (RAM) or another type of dynamic storage device that stores information or instructions for execution by processing unit 320. ROM 340 may include a ROM device or another type of static storage device that stores static information or instructions for use by processing unit 320. Storage device 350 may include a magnetic storage medium, such as a hard disk drive, or a removable memory, such as a flash memory.

Input device 360 may include a mechanism that permits an operator to input information to device 300, such as a control button, a keyboard, a keypad, or another type of input device. Output device 370 may include a mechanism that outputs information to the operator, such as a light emitting diode (LED), a display, or another type of output device. Communication interface 380 may include any transceiver-like mechanism that enables device 300 to communicate with other devices or networks (e.g., network 240). In one implementation, communication interface 380 may include a wireless interface and/or a wired interface.

Device 300 may perform certain operations, as described in detail below. Device 300 may perform these operations in response to processing unit 320 executing software instructions contained in a computer-readable medium, such as main memory 330. A computer-readable medium may be defined as a non-transitory memory device. A memory device may include memory space within a single physical memory device or spread across multiple physical memory devices.

The software instructions may be read into main memory 330 from another computer-readable medium, such as storage device 350, or from another device via communication interface 380. The software instructions contained in main memory 330 may cause processing unit 320 to perform processes that will be described later. Alternatively, hardwired circuitry may be used in place of or in combination with software instructions to implement processes described herein. Thus, implementations described herein are not limited to any specific combination of hardware circuitry and software.

Although FIG. 3 shows example components of device 300, in other implementations, device 300 may include fewer components, different components, differently arranged components, and/or additional components than those depicted in FIG. 3. Alternatively, or additionally, one or more components of device 300 may perform one or more tasks described as being performed by one or more other components of device 300.

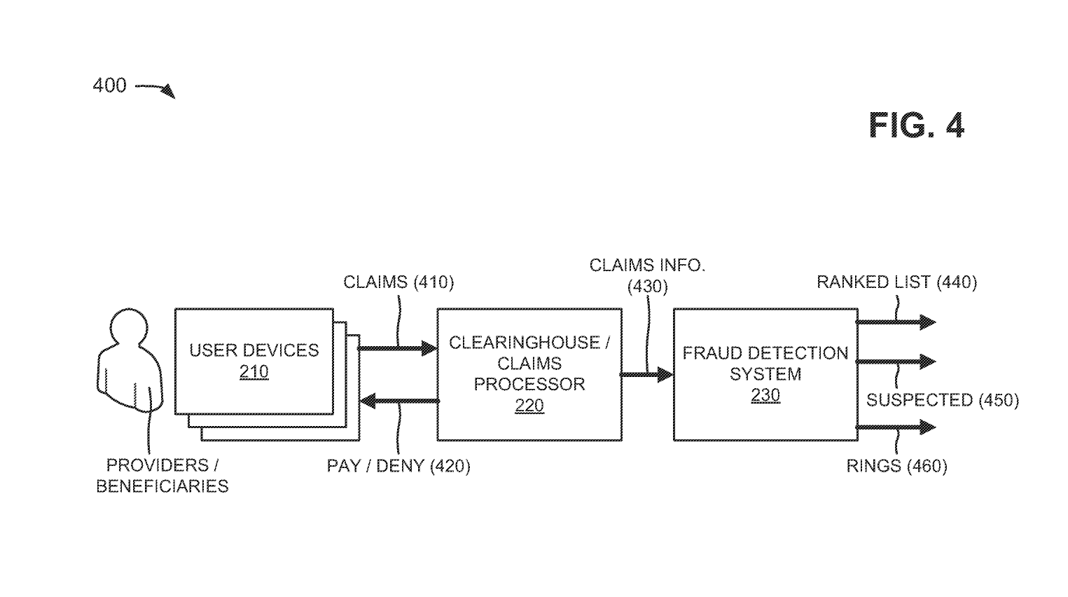

FIG. 4 is a diagram of example interactions between components of an example portion 400 of environment 200. As shown, example portion 400 may include user devices 210, clearinghouse/claims processor system 220, and fraud detection system 230. User devices 210, clearinghouse/claims processor system 220, and fraud detection system 230 may include the features described above in connection with, for example, one or more of FIGS. 1-3.

Beneficiaries may or may not receive healthcare services from providers associated with user devices 210. As further shown in FIG. 4, whether or not the providers legitimately provided the healthcare services to the beneficiaries, user devices 210 may generate claims 410. Claims 410 may be provided to clearinghouse/claims processor system 220. Claims 410 may include interactions of providers with clearinghouse/claims processor system 220 or another entity responsible for paying for beneficiaries' healthcare or medical expenses, or a portion thereof. Claims 410 may be either legitimate or fraudulent.

Clearinghouse/claims processor system 220 may make minor changes to claims 410, and may pay or deny the claims, as indicated by reference number 420. If a particular claim 410 is paid, clearinghouse/claims processor system 220 may provide money to the provider who submitted the particular claim 410. If a particular claim 410 is denied, clearinghouse/claims processor system 220 may provide an indication of the denial to the provider who submitted the particular claim 410. After paying claims 410, clearinghouse/claims processor system 220 may forward the paid claims 410 to a zone program integrity contractor (not shown). Alternatively, or additionally, clearinghouse/claims processor system 220 may provide claim information 430 associated with claims 410, such as provider information, beneficiary information, healthcare service information, billing information, etc., to fraud detection system 230.

In one example implementation, fraud detection system 230 may receive claims information 430, and may update claims information 430 in real-time. For example, fraud detection system 230 may update claims information 430 daily (e.g., after each day of accumulated claims 410). Alternatively, or additionally, fraud detection system 230 may update claims information 430 using a sliding window of claims 410 over a time period, such as a year or longer. The updated claims information 430 may enable fraud detection system 230 to receive any changes in beneficiary and/or provider behavior that evolve over time.

In one example, claims information 430 may include a set of claims 410 over a particular time period. The set of claims 410 may be associated with a particular geographical area and a contiguous time period. The particular geographical area may correspond to a large area, such as a state (e.g., Massachusetts), a region (e.g., the Northeast United States), etc. The contiguous time period may be a month, months, a year, more than a year, etc.

Assume that a set of claims (C) is received over a total time period (T) (e.g., in days, where a discrete unit of time is one day). For each claim (c) of the set of claims (C) (e.g., cεC), assume that:
d(c) is a label for a provider associated with the claim (c);
ld(c) is a geographic location of the provider d(c);
p(c) is a label for a beneficiary associated with the claim (c);
lp(c) is a geographic location of a residence of the beneficiary p(c);
f(c) is a first day of service for the claim (c);
e(c) is a final day of service for the claim (c); and
sd(c) is a label of a specialty associated with the provider d(c).
   Each claim (c) may include more or less information depending on the set of claims (C).

A geographic location may be provided in a variety ways. For example, the geographic location may correspond to a street address, a zip code, latitude and longitude coordinates, global positioning system (GPS) coordinates, etc. Fraud detection system 230 may utilize a mechanism to determine a geographic distance between two geographic locations. For example, fraud detection system 230 may determine a geographic distance between geographic locations (e.g., g₁ and g₂) with a function (e.g., Δ(g₁, g₂)). Depending on the form of the geographic location (e.g., a street address, GPS coordinates), the distance may be an exact measure or an approximate measure. Fraud detection system 230 may partition the geographic locations in the geographical area into a set (Z) of geographic zones. A geographic zone may correspond to, for example, a street address, a zip code, etc., and may include a centroid. In one example, a geographic zone of a first geographic location may be represented as z(l).

Fraud detection system 230 may receive claims information 430 from clearinghouse/claims processor system 220, and may process claims information 430 to produce first fraud sets that may be members of postulated classes of organized healthcare fraud. Fraud detection system 230 may perform data mining techniques on claims information 430 to produce second fraud sets from claims information 430. Each of the first and second fraud sets may include a set of claims or a derivative fraud set. Fraud detection system 230 may calculate observations without fraud (or “no fraud” observations) using a gravitational model of aggregate numbers and loci associated with claims information 430. Fraud detection system 230 may calculate probabilities that the first and second fraud sets are statistically the same as the no fraud observations. Fraud detection system 230 may rank the first and second fraud sets based on the calculated probabilities.

Fraud detection system 230 may output (e.g., provide for display) and/or store a ranked list 440 of suspected fraud cases based on the ranking of the first and second fraud sets. Alternatively, or additionally, fraud detection system 230 may output (e.g., provide for display) and/or store suspected fraud cases 450 included in the first and second fraud sets. Fraud detection system 230 may set thresholds for the calculated probabilities based on either an ability to investigate fraud or on a specified low probability of non-fraudulence. Fraud detection system 230 may identify rings 460 of fraudulent providers based on the set thresholds and on the fraudulent providers' frequent associations with other fraudulent providers. Fraud detection system 230 may output (e.g., provide for display) and/or store rings 460 of fraudulent providers.

Although FIG. 4 shows example components of example portion 400, in other implementations, example portion 400 may include fewer components, different components, differently arranged components, and/or additional components than those depicted in FIG. 4. Alternatively, or additionally, one or more components of example portion 400 may perform one or more tasks described as being performed by one or more other components of example portion 400.

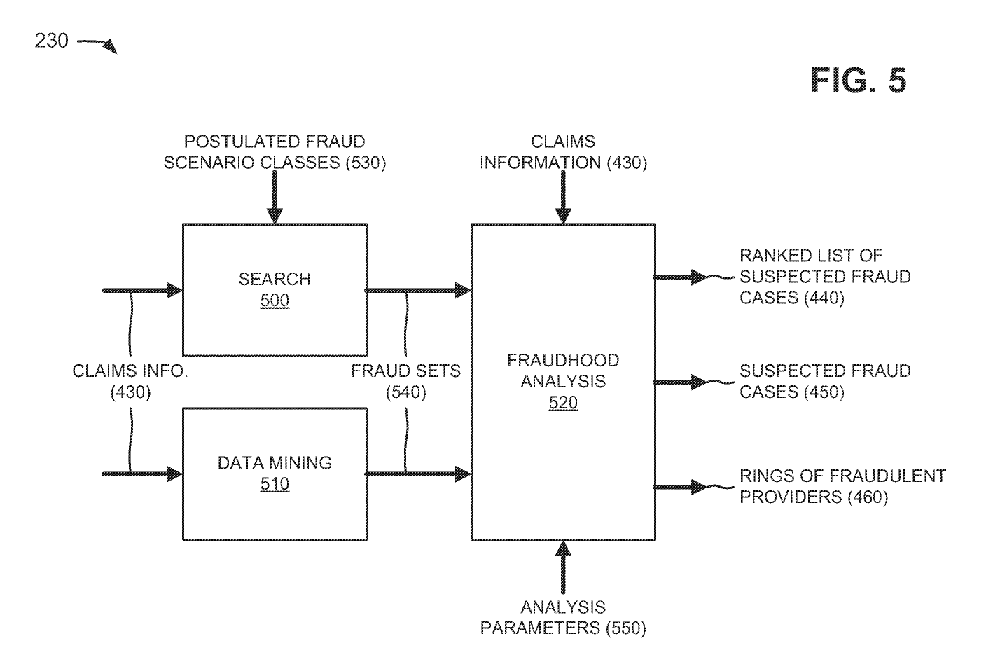

FIG. 5 is a diagram of example functional components of fraud detection system 230. In one implementation, the functions described in connection with FIG. 5 may be performed by one or more components of device 300 (FIG. 3) or by one or more devices 300. As shown in FIG. 5, fraud detection system 230 may include a search component 500, a data mining component 510, and a fraudhood analysis component 520.

Search component 500 may receive claims information 430 from clearinghouse/claims processor system 220, and may receive postulated fraud scenario classes 530 (e.g., from a user of fraud detection system 230). Each of postulated fraud scenario classes 530 may include a postulated set of criteria that, if met by a set of claims taken together, may be indicative of possible organized healthcare fraud. Search component 500 may process claims information 430 to produce first fraud sets 540 that may be members of postulated fraud scenario classes 530. Each of fraud sets 540 may include a set of claims that, taken together, may be of possible interest in detecting organized healthcare fraud. Search component 500 may provide the first fraud sets 540 to fraudhood analysis component 520.

In one example implementation, one of postulated fraud scenario classes 530 may be defined by Ψ. For example, Ψ=(a, b, c, d, δ) may include a class of scenarios in which a specific set of at least (a) and at most (b) beneficiaries visit a specific set of at least (c) and at most (d) providers, such that a minimum distance between any of the beneficiaries and providers may be at least (δ).

Search component 500 may search for potential fraud scenarios that belong to postulated fraud scenario classes 530. For example, search component 500 may identify the potential fraud scenarios by examining state trajectories of the beneficiaries and by locating sets of state trajectory vectors that correspond to scenarios in postulated fraud scenario classes 530. If no sets of state trajectory vectors are located, search component 500 may determine that there are no fraud scenarios, of postulated fraud scenario classes 530, to be analyzed for potential fraud.

A fraud set 540 may include, for example, a set of beneficiaries with state trajectory vectors that correspond to scenarios in postulated fraud scenario classes 530. A fraud set 540 may include a set of claims 410 that, when taken together, correspond to a potential fraud scenario that belongs to postulated fraud scenario classes 530.

In one example, search component 500 may formulate other postulated fraud scenario classes 530. The example provided above (e.g., where Ψ=(a, b, c, d, δ)) may be just one example that is defined for formulating postulated fraud scenario classes 530. The other postulated fraud scenario classes 530 may utilize other types of constraints. For example, the other postulated fraud scenario classes 530 may impose minimum distance constraints between providers, may include constraints associated with a time between visits to providers, etc.

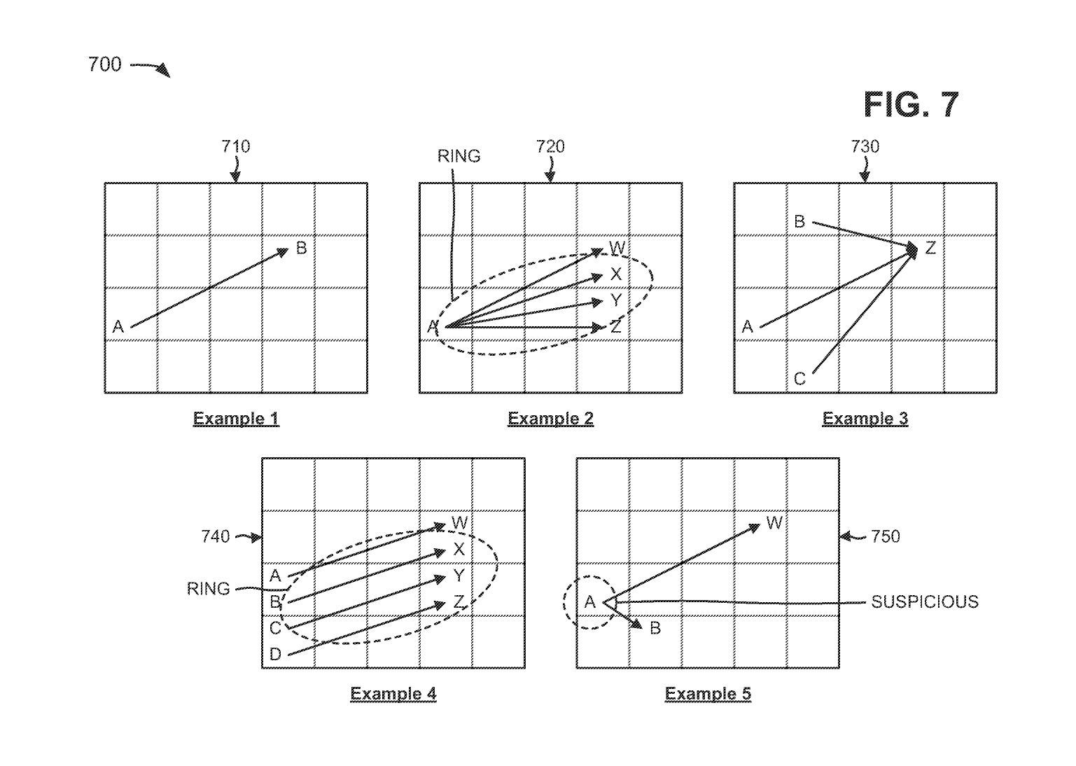

Search component 500 may receive a wide variety of common fraud scenarios for postulated fraud scenario classes 530. For example, postulated fraud scenario classes 530 may include any of example fraud scenarios 700 depicted in FIG. 7. As shown in FIG. 7, a first example fraud scenario 710 may include a situation where a number of beneficiaries of one home provider (A) use another specific provider (B) in a remote zip code. The home provider (A) and the remote provider (B) may use their names to generate fraudulent bills, and the beneficiaries may receive kickbacks from either fraudulent provider.

A second example fraud scenario 720 may include a situation where a number of beneficiaries of one home provider (A) use several remote providers (W, X, Y, and Z) in remote locations. Some or all of the providers may generate fraudulent bills, and may be part of a ring, although the providers may not all know every other provider in the ring.

A third example fraud scenario 730 may include a situation where beneficiaries with various home providers (A, B, and C) use the same remote provider (Z). The remote provider (Z) may recruit the beneficiaries for fraudulent treatment. The remote provider (Z) may commit fraud, and some or none of the home providers (A, B, and C) may commit fraud.

A fourth example fraud scenario 740 may include a situation where beneficiaries from a ring of home providers (A, B, C, and D) use one of several remote providers (W, X, Y, and Z) who are part of the same ring.

A fourth example fraud scenario 750 may include a situation where beneficiaries who frequent a known suspicious provider (A) also use another specific provider (B or W) who may or may not be remotely located.

One characteristic of example fraud scenarios 700 may be that pairs of providers are remotely located from each other. Another characteristic of example fraud scenarios 700 may be that frequent pairs of providers may commit fraud if one or both providers are part of a suspected ring. Search component 500 may detect fraud, in example fraud scenarios 700, through particular functions of beneficiary trajectories. For example, fraud may be detected in example fraud scenarios 700 by summing over intermediate visits, and by identifying combinations of providers who are visited during a time period and are not visited during other time periods.

Returning to FIG. 5, data mining component 510 may receive claims information 430, and may perform data mining techniques on claims information 430 to produce second fraud sets 540 from claims information 430. Data mining component 510 may provide the second fraud sets 540 to fraudhood analysis component 520. Each of fraud sets 540 (e.g., the first fraud sets 540 and the second fraud sets 540) may include a set of claims 410. Alternatively, or additionally, each of fraud sets 540 may include a derivative fraud set. A derivative fraud set may include a set of beneficiary state trajectories. A beneficiary state trajectory may include, for example, an ordered sequence of providers that may be visited by a beneficiary over a particular time period.

In one example implementation, data mining component 510 may utilize various data mining techniques. For example, data mining component 510 may utilize the following data mining technique. From claims information 430, a state trajectory matrix T(p) may become available for each set of comparable beneficiaries (n) over a specific time period (e.g., a year). Beneficiaries may be defined as comparable if the beneficiaries are undergoing treatment for a specific condition (e.g., arthritis) or are from the same geographic location (e.g., the same zip code). The state trajectory matrix T(p) may include elements that show which provider (Pₖ) was visited at a particular time (t). Rows of the state trajectory matrix T(p) may include transactions of individual beneficiaries and may include providers visited over a particular time period.

Data mining component 510 may automatically identify frequent suspicious visits. In practice, there may be thousands of providers and, therefore, millions of combinations of visited providers (e.g., where most combinations may include zero suspicious visits). Data mining component 510 may focus on a number of beneficiary visits to, for example, providers A, B, and C, and for most beneficiaries, such a random combination may occur infrequently or not at all. Data mining component 510 may locate the provider combinations that occur among a substantial number of beneficiaries. Examination of these combinations may be used by data mining component 510 to specify a fraud class (e.g., one of postulated fraud scenario classes 530) of beneficiaries to test for involvement in potentially fraudulent behavior.

Data mining component 510 may discover frequent patterns of suspicious behavior in the state trajectory matrices using affinity analysis or market basket analysis. In the market basket analysis, each row of a matrix may represent a trip to a store, columns of the matrix may represent items for sale, and cells of the matrix may be non-zero when the trip results in a purchase of an item. Matrices in this format may have many zero cells and may be efficiently analyzed by one of several algorithms (e.g., an a priori algorithm). Standard formulations of these algorithms may identify high-coverage or high-confidence association rules. In the market basket analysis, the association rules may be of the form “if bananas and bread are purchased, then so is peanut butter.” An analog for a beneficiary/provider scenario may be of the form “if providers A and B are visited during the time period, then so is provider C.” The algorithms may be set up to show similar rules with: (1) high coverage, where at least X_{ABC} beneficiaries visit providers A, B, and C; and (2) high confidence, where of those beneficiaries who visit providers A and B, a high proportion of those beneficiaries also visit provider C.

In each of example fraud scenarios 700 of FIG. 7, a measure of fraud may include a set of beneficiary visits with certain characteristics. For example, in first example fraud scenario 710, a number of beneficiaries may visit the provider (A) and may also visit the remote provider (B). In one example, data mining component 510 may restrict the association rules (i.e., combinations of providers visited) to those rules with some minimum coverage, on the grounds that anti-fraud teams are most interested in high-volume fraud, and also on statistical grounds that a high frequency results in a higher probability of a combination being fraudulent.

Fraudhood analysis component 520 may receive fraud sets 540, and may receive claims information 430 and analysis parameters 550. Analysis parameters 550 may include one or more parameters to be used by fraudhood analysis component 520 on fraud sets 540. In one example, fraudhood analysis component 520 may calculate observations without fraud (or “no fraud” observations) using a gravitational model of aggregate numbers and loci associated with claims information 430. Fraudhood analysis component 520 may calculate probabilities that fraud sets 540 are statistically the same as the no fraud observations. Fraudhood analysis component 520 may rank fraud sets 540 based on the calculated probabilities. In one example, fraudhood analysis component 520 may provide a higher rank to a fraud set 540 with a lower probability of being non-fraudulent than another fraud set 540 with a higher probability of being non-fraudulent.

Fraudhood analysis component 520 may output (e.g., provide for display) and/or store ranked list 440 of suspected fraud cases based on the ranking of fraud sets 540. Alternatively, or additionally, fraudhood analysis component 520 may output (e.g., provide for display) and/or store suspected fraud cases 450 found in fraud sets 540. Fraudhood analysis component 520 may set thresholds for the calculated probabilities based on either an ability to investigate fraud or on a specified low probability of non-fraudulence. Fraudhood analysis component 520 may identify rings 460 of fraudulent providers based on the set thresholds and on the fraudulent providers' frequent associations with other fraudulent providers. Fraudhood analysis component 520 may output (e.g., provide for display) and/or store rings 460 of fraudulent providers.

Although FIG. 5 shows example functional components of fraud detection system 230, in other implementations, fraud detection system 230 may include fewer functional components, different functional components, differently arranged functional components, and/or additional functional components than those depicted in FIG. 5. Alternatively, or additionally, one or more functional components of fraud detection system 230 may perform one or more tasks described as being performed by one or more other functional components of fraud detection system 230.

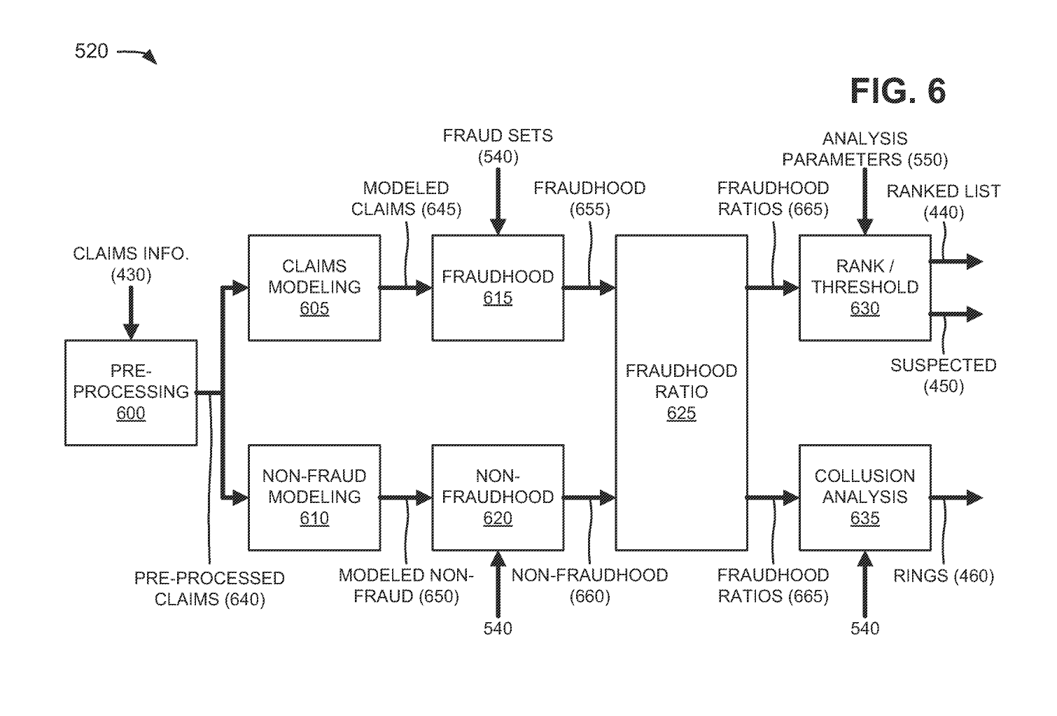

FIG. 6 is a diagram of example functional components of fraudhood analysis component 520. In one implementation, the functions described in connection with FIG. 6 may be performed by one or more components of device 300 (FIG. 3) or by one or more devices 300. As shown in FIG. 6, fraudhood analysis component 520 may include a pre-processing component 600, a claims modeling component 605, a non-fraud modeling component 610, a fraudhood component 615, a non-fraudhood component 620, a fraudhood ratio component 625, a rank/threshold component 630, and a collusion analysis component 635.

Pre-processing component 600 may receive claims information 430, and may process claims information 430 (e.g., using data filtering, data cleansing, etc.) to produce pre-processed claims 640. Pre-processing component 600 may provide pre-processed claims 640 to claims modeling component 605 and non-fraud modeling component 610.

In one example implementation, pre-processing component 600 may group specialties of providers into several categories. A highest category (e.g., category A) may correspond to elite specialists (e.g., heart surgeons, brain surgeons, etc.) that provide specific extraordinary services. Lower categories may correspond to decreasing levels of specialization and/or training requirements. For example, if there are four categories, then category B may correspond to ordinary specialists (e.g., ophthalmologists, orthopedic surgeons, general surgeons, etc.) that see beneficiaries that have common significant conditions. Category C may correspond to ordinary doctors (e.g., family doctors, general practice doctors, clinical doctors, etc.) that see beneficiaries for common conditions, routine care, checkups, etc. Category D may correspond to other professionals (e.g., chiropractors, podiatric physicians, nurses, counselors, psychologists, etc.) who are not full-fledged medical doctors but see beneficiaries for common conditions and routine care.

Pre-processing component 600 may perform data filtering on claims information 430 in order to render claims information 430 into an expected form. Pre-processing component 600 may delete all claims that involve providers of category (CAT) A (i.e., for cεC, pre-processing component 600 may delete claim (c) if CAT(sd(c))=A). Pre-processing component 600 may delete all claims in category A since it may be assumed that elite specialists may not partake in organized fraud. Furthermore, such elite specialists, being relatively few in number and highly specialized in certain procedures, may naturally draw beneficiaries from a very wide geographic area.

Pre-processing component 600 may assume that there are no beneficiaries that receive service from more than one provider in any particular day. If otherwise, pre-processing component 600 may extend or generalize models to account for beneficiaries that receive service from more than one provider in any particular day. For example, pre-processing component 600 may extend Markov chain models to include states corresponding to pairs or triples of providers visited in a particular day. If there are claims where beneficiaries receive service from more than one service provider in a particular day, pre-processing component 600 may discard such claims that involve a higher category of provider. Other rules for discarding such claims may also be formulated and applied by pre-processing component 600.

Claims modeling component 605 may receive pre-processed claims 640, and may develop a mathematical claims model for pre-processed claims 640 using mathematical modeling techniques, such as, for example, a Markov chain model of realized claims behavior, other simpler or more complex types of mathematical models, etc. Claims modeling component 605 may provide the modeled pre-processed claims 640 to fraudhood component 615, as indicated by reference number 645.

In one example implementation, the mathematical claims model developed for modeling pre-processed claims 640 may depend on information available in pre-processed claims 640 and a type of organized fraud to be detected. For example, claims modeling component 605 may develop an empirical claims model based on Markov chain modeling. The empirical claims model may assume that a geographic location, or at least a geographic area, of each beneficiary is known. In the empirical claims model, one Markov chain may be constructed for each geographic area. A simpler empirical claims model, consisting of one single Markov chain model, may also be developed for claims missing geographic location information of the beneficiaries. The empirical claims models may also be limited to the modeling of claims that relate to certain specific types of conditions.

In the empirical claims model, a set of beneficiaries may be denoted by P, and the set of beneficiaries (P) with residence in a zone (z) (e.g., zεZ) may be denoted by P(z). A set of providers visited by the beneficiaries, with a residence in the zone (z), may be denoted by SP(z). The set of providers may include providers with geographic locations that are in zones different than the zone (z).

For each beneficiary (p) (e.g., pεP(z)), the empirical claims model may define an ordered state trajectory vector (e.g., t(p)=[t₁ₚ, . . . , t_{Tp}]) of providers visited over a discrete-time time period (e.g., 1, . . . , T days). The element (t₁ₚ) may be a label for a provider that beneficiary (p) visits at time period (i). If no provider is visited at time period (i), then tᵢₚ=φ, where φ is a null element. A time period of each beneficiary visit to each provider may be known from a set of claims (C). When a provider service lasts more than one day, the state trajectory vector may show a series of consecutive visits to the same provider.

A state trajectory matrix for the zone (z) may be defined by T(z)=t(p), where pεP(z)]. For each zone (z), claims modeling component 605 may construct a discrete-time Markov chain model of the providers that are visited by the set of beneficiaries P(z). The Markov chain model may be specified by a state transition probability matrix P(z)=[pᵢⱼ(z)], where pᵢⱼ(z) is a transition probability from state i to state j for beneficiaries with residence in zone (z), i and jεS(z), and S(z) is a state space.

A space of state space S(z) may include one “home” state (e.g., labeled “0”), one “service provider” state for each provider in SP(z), and a set of additional inter-service provider “delay” states. The delay states may account for non-zero transition delays for beneficiaries transitioning from one provider in SP(z) to another provider in SP(z), transitioning from the home state to a first provider in SP(z), or transitioning from a provider in SP(z) to the home state. Non-zero transition delays may exist when there is at least one null element (φ) in a state trajectory vector t(p).

The state transition probability matrix P(z) may model visits, of beneficiaries in P(z), over time to providers in SP(z). The state transition probability matrix P(z) may model inter-provider delays. For example, a beneficiary (p) may start out in the home state prior to the time period (1, . . . , T), may transition through the service provider state and the inter-service provider delay states according to a trajectory t(p), and may return to the home state after time period (T). The Markov chain modeling may condense the information in the state trajectory matrix T(z) to the information in the transition matrix P(z).

Claims modeling component 605 may determine transition probabilities pᵢⱼ(z) by first defining the labeling of the states. For example, the home state may be labeled “0,” and a label of a state associated with a particular provider may be set equal to a label of the provider. A label of an inter-service provider delay state may be set equal to “label1-label2,” where “label1” may include a label of a state from which the transition to the delay state is emanating and “label2” may include a label of a state to which the transition from the delay state is being directed.

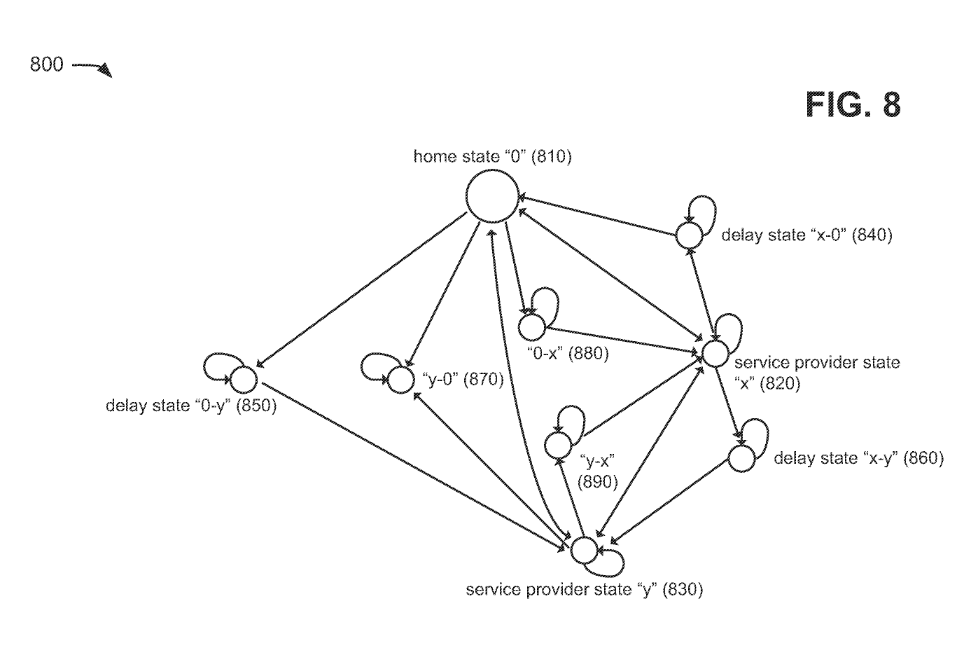

FIG. 8 is a diagram of example state labeling and state transitions 800 in a claims model created by claims modeling component 605. As shown in FIG. 8, a home state 810 may be labeled “0,” a service provider state 820 may be labeled “x,” and another service provider state 830 may be labeled “y.” A first inter-service provider delay state 840 may be labeled “x-0,” a second inter-service provider delay state 850 may be labeled “0-y,” a third inter-service provider delay state 860 may be labeled “x-y,” a fourth inter-service provider delay state 870 may be labeled “y-0,” a fifth inter-service provider delay state 880 may be labeled “0-x,” and a sixth inter-service provider delay state 890 may be labeled “y-x.”

For i=0 and j=0, claims modeling component 605 may set p₀₀(z)=0, since it may be assumed that there is no self-looping state transition at the home state. Claims modeling component 605 may determine the transition probabilities out of the home state. Claims modeling component 605 may determine the transition probabilities for transitions that are directed directly from the home state to a service provider state. It may be assumed that n(1, s), sεSP(z) is a number of vectors in T(z) in which t₁ₚ=s, where n(1, s) is a number of times that a beneficiary first visits provider (s) at time period (1). Claims modeling component 605 may set p₀ₛ(z)=n(1, s)/|P(z)|.

Claims modeling component 605 may determine transition probabilities for transitions that are directed from the home state to an inter-service provider delay state. It may be assumed that n(s), sεSP(z) is a number of vectors in T(z) in which a first entry is equal to the null entry (φ) and a following first non-null entry is equal to s, where n(s) is a number of times that a beneficiary first visits a provider (s) at time period (2) or later. Claims modeling component 605 may set p₀₀₋ₛ(z)=n(s)/|P(z)|.

Claims modeling component 605 may determine a self-looping transition probability at inter-service provider delay states with a label “0-x,” where “x” is a label of a service p₀₋ₓ₀₋ₓ(z) provider. The inter-service provider delay states may be directly reachable from the home state. The self-looping transition probability may be set to model a delay between leaving the home state and arriving in the service provider state “x.” It may be assumed that A(z, x) is an average number of consecutive null entries in the vectors in T(z) that start with a null entry and end just before an “x” entry. Claims modeling component 605 may set:

$${p}_{0 - x 0 - x} ( x ) = \frac{A ( z , x )}{1 + A ( z , x )} ,$$

which may correspond to modeling a delay distribution of the number of consecutive null entries (or consecutive days) before reaching state “x,” as a geometric distribution.

Claims modeling component 605 may determine a transition probability p₀₋ₓₓ(z) from the inter-service provider delay state “0-x” to state “x,” as follows: p₀₋ₓₓ(z)=1−p₀₋ₓ₀₋ₓ(z). Claims modeling component 605 may determine transition probabilities out of a service provider state “x.” For example, service provider state “x” may include a self-looping transition, a transition directly to another provider state “y,” a transition to an inter-service provider delay state “x-y,” a transition directly from state “x” to the home state, and a transition to the inter-service provider delay state “x-0.” It may be assumed that k(x, x, 0) is a number of occurrences of an entry “x” in T(z) that is followed immediately by another entry “x;” k(x, y, 0) is a number of occurrences of an entry “x” in T(z) that is followed immediately by an entry “y;” and k(x, y, 1) is a number of occurrences of an entry “x” in T(z) that is followed by an entry “y” after one or more null entries. It may be assumed that k(x, 0, 0) is a number of occurrences of an entry “x” in T(z) that is followed immediately by the home state “0;” and k(x, 0, 1) is a number of occurrences of an entry “x” in T(z) that is followed by the home state after one or more null entries. If G is a normalization constant, claims modeling component 605 may set the following:

pₓₓ(z)=Gk(x,x,0),

p_{xy}(z)=Gk(x,y,0),

p_{xx-y}(z)=Gk(x,y,1),

pₓ₀(z)=Gk(x,0,0),

pₓₓ₋₀(z)=Gk(x,0,1), and

G=k(x,x,0)+k(x,y,0)+k(x,y,1)+k(x,0,0)+k(x,0,1).

Non-fraud modeling component 610 may receive pre-processed claims 640, and may use pre-processed claims 640 to create a mathematical model (e.g., a model of gravitational effects) of non-fraudulent claims behavior. Non-fraud modeling component 610 may provide the non-fraud modeled pre-processed claims 640 to non-fraudhood component 620, as indicated by reference number 650.

In one example implementation, the mathematical model developed for modeling pre-processed claims 640 may include an empirical gravity model, a theoretical gravity model, a hybrid empirical-theoretical gravity model, etc. For example, there may be situations where the theoretical gravity model may not be effective. In such situations, non-fraud modeling component 610 may define an empirical gravity model based on a total number of beneficiary visits from one location to another location, as follows: gᵢⱼ(z)=(number of beneficiary trajectories containing both z(i) and z(j))/(number of beneficiary trajectories containing z(i)).

An example hybrid empirical-theoretical gravity model may be based on Markov chain modeling. A Markov chain gravity model G(z)=[gᵢⱼ(z)] may be constructed that corresponds to each of the constructed Markov chains P(z)=[pᵢⱼ(z)]. The gravity model G(z) may be a modified version of the transition matrix P(z) that is designed to reflect expected gravitational behavior effects in a choice of providers made by beneficiaries. It may be assumed that for services requiring providers in categories B through D, beneficiaries may seek out providers that are local to them, or at least in their general geographic vicinity. Physical convenience, practicality, and/or transportation cost may make it more attractive to seek a provider that is closer to where a beneficiary lives. In the gravity model, a probability of a beneficiary visiting a particular provider with a given specialty may be made inversely proportion to a square of a distance to the provider. However, non-fraud modeling component 610 may distinguish between providers that are in a “near-field,” where the inverse square law is assumed to be not applicable on a per service provider basis, and providers that are in “far-field,” where the inverse square law is assumed to apply to individual providers.

For each zone (z), non-fraud modeling component 610 may define a set SPₙₑₐᵣ(z) of providers that are near-field to the zone (z) and a set SP_{far}(z) of providers that are far-field to the zone (z). The set SPₙₑₐᵣ(z) may include all providers in SP(z) and SP(z)=SPₙₑₐᵣ(z)+SP_{far}(z). In the “near-field” region, the inverse square gravity law may be assumed to not hold since there may be many known or unknown factors, besides distance, why one provider might be chosen over another provider within a same specialty when the providers are in the same “near-field” region. In the Markov chain gravity model, transition probabilities to providers in SPₙₑₐᵣ(z) may not be modified relative to one another compared to P(z). However, non-fraud modeling component 610 may not account for an overall nearness of the providers in the “near-field” region compared to providers in the “far-field” region. In the “far-field” region, the inverse square gravity law may be assumed to be a valid model of provider choice and the transition probabilities to providers in SP_{far}(z) may be modified relative to one another.

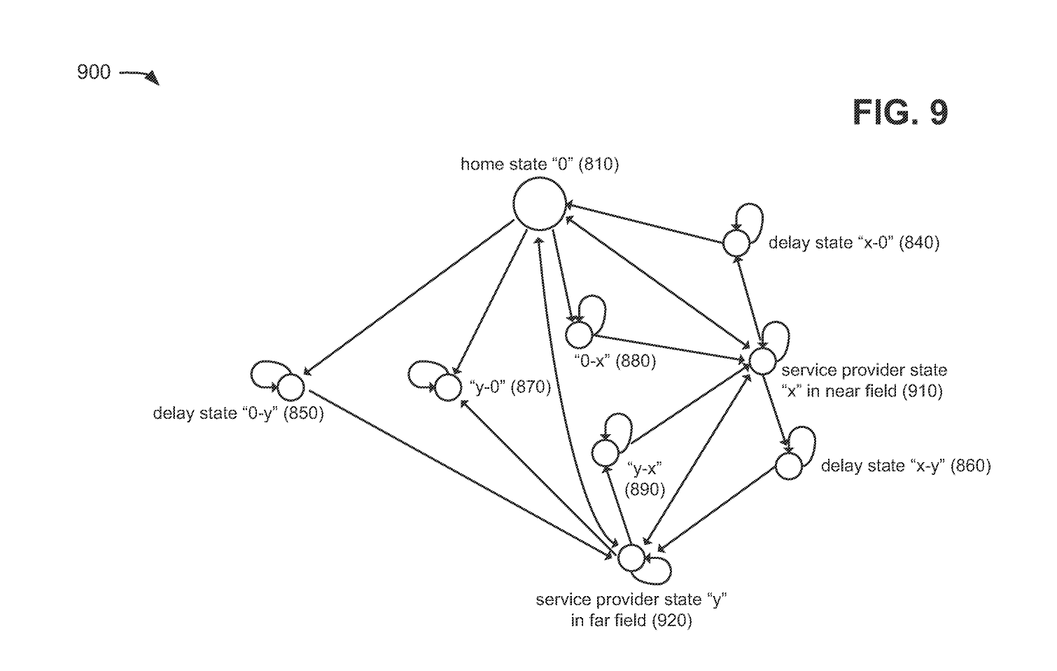

FIG. 9 is a diagram of example modified and unmodified transition probabilities 900 in the claims model of FIG. 8. FIG. 9 may include the features of FIG. 8, as described above. However, as shown in FIG. 9, service provider state 820 (labeled “x”) may be in a near-field region, as shown by reference number 910, and service provider state 830 (labeled “y”) may be in a far-field region, as shown by reference number 920. The transition probabilities to far-field service provider 920 may be modified relative to one another in P(z) to form G(z). The transition probabilities to far-field service provider 920 may not be modified relative to one another, but may be modified together as a group by a distance factor. The other transition probabilities may remain unmodified.

The transition probabilities may be modified as follows. It may be assumed that χₚ(z) is a geographic position of a centroid for geographic positions of beneficiaries in P(z), that χₛ(z) is a geographic position of a centroid for geographic positions of providers in neither SPₙₑₐᵣ(z), and that Γ(x) is a geographic location of provider “x.” For a state “x,” where “x” is the home state nor an inter-service provider delay state, and where y=x, non-fraud modeling component 610 may set gₓₓ(z)=pₓₓ(z), which maintains a same self-looping probability to maintain a same holding time in state “x” as in P(z).

In the case where yεSP_{far}(z), non-fraud modeling component 610 may set g_{xy}(z)=(1/Δ(χₚ(z), Γ(y))²)·G_{pxy}(z), and g_{xx-xy}(z)=(1/Δ(χₚ(z), Γ(y))²)·G_{pxx-y}(z). This may weight the transitions to each particular far-field provider with a distance to the provider, but may maintain relative values of a direct transition (e.g., x to y) and an accompanying transition (x to x-y) to the delay state.

In the case where yεSPₙₑₐᵣ(Z), non-fraud modeling component 610 may set g_{xy}(z)=(1/Δ(χₚ(z), χₛ(z))²)·G_{pxy}(z), and g_{xx-y}(z)=(1/Δ(χₚ(z), χₛ(z))²)·G_{pxx-y}(z). This may weight the transitions to the near-field providers with a distance factor (e.g., 1/Δ(χₚ(z), χₛ(z))²), but may maintain relative values of direct transitions and accompanying transitions to the delay state.

In the case where y=0, non-fraud modeling component 610 may set gₓ₀(z)=pₓ₀(z) and gₓₓ₋₀(z)=pₓₓ₋₀(z). This may maintain the same transition probabilities from “x” to the home state to maintain the same delays in going from “x” to the home state as in P(z). A normalization constant (G) may ensure that a sum of the transition probabilities is equal to one and may be given by:

$$G = \frac{1 - {p}_{x 0} ( z ) - {p}_{xx - 0} ( z ) - {p}_{xx} ( z )}{\begin{matrix}{\sum }_{y ∈ {SP}_{far} ( z )} {( \frac{1}{Δ ( {χ}_{p} ( z ) , Γ ( y ) )} )}^{2} {p}_{xy} ( z ) + {\sum }_{y ∈ {SP}_{far} ( z )} {( \frac{1}{Δ ( {χ}_{p} ( z ) , Γ ( y ) )} )}^{2} {p}_{xx - y} ( z ) + \\ {\sum }_{y ∈ {SP}_{near} ( z )} {( \frac{1}{Δ ( {χ}_{p} ( z ) , {χ}_{s} ( z ) )} )}^{2} {p}_{xy} ( z ) + {\sum }_{y ∈ {SP}_{near} ( z )} {( \frac{1}{Δ ( {χ}_{p} ( z ) , {χ}_{s} ( z ) )} )}^{2} {p}_{xx - y} ( z )\end{matrix}}$$

When state x=0 and y=0, non-fraud modeling component 610 may set g₀₀(z)=0 since p₀₀(z)=0. In the case where yεSP_{far}(z), non-fraud modeling component 610 may set g_{0y}(z)=(1/Δ(χₚ(z), Γ(y))²)·G_{p0y}(z), and g_{00-y}(z)=(1/Δ(χₚ(z), Γ(y))²)·G_{p00-y}(z). In the case where yεSPₙₑₐᵣ(Z), non-fraud modeling component 610 may set g_{0y}(z)=(1/Δ(χₚ(z), χₛ(z))²)·G_{p0y}(z), and g_{00-y}(z)=(1/A(χₚ(z), χₛ(z))²)·G_{p00-y}(z). The normalization constant (G) may be given by:

$$G = \frac{1}{\begin{matrix}{\sum }_{y ∈ {SP}_{far} ( z )} {( \frac{1}{Δ ( {χ}_{p} ( z ) , Γ ( y ) )} )}^{2} {p}_{xy} ( z ) + {\sum }_{y ∈ {SP}_{far} ( z )} {( \frac{1}{Δ ( {χ}_{p} ( z ) , Γ ( y ) )} )}^{2} {p}_{xx - y} ( z ) + \\ {\sum }_{y ∈ {SP}_{near} ( z )} {( \frac{1}{Δ ( {χ}_{p} ( z ) , {χ}_{s} ( z ) )} )}^{2} {p}_{xy} ( z ) + {\sum }_{y ∈ {SP}_{near} ( z )} {( \frac{1}{Δ ( {χ}_{p} ( z ) , {χ}_{s} ( z ) )} )}^{2} {p}_{xx - y} ( z )\end{matrix}}$$

When state “x” is an inter-service provider delay state and y=x, non-fraud modeling component 610 may set gₓₓ(z)=pₓₓ(z). In the case where yεSP_{far}(z) or yεSPₙₑₐᵣ(z), non-fraud modeling component 610 may set g_{xy}(z)=p_{xy}(z).

Fraudhood component 615 may receive fraud sets 540 and modeled claims 645, and may calculate, for each fraud set 540, a fraudhood measure 655. Fraudhood measure 655 may include a measure of a likelihood of fraud set 540 being produced given modeled claims 645. Fraudhood component 615 may provide fraudhood measures 655 to fraudhood ratio component 625.

In one example implementation, fraudhood component 615 may, in the Markov chain model, calculate fraudhood measure 655 (F_{MCM}) for a scenario involving a set (FRAUD) of beneficiaries as follows:

$${F}_{MCM} = {\prod }_{p ∈ FRAUD} {π}_{MCM} ( t ( p ) ) ,$$

where π_{MCM}(t(p)) is a probability of a state trajectory realization t(p) in the Markov chain model. The state trajectory realization probability may be given by a product of the transition probabilities of the state transitions that are followed in the state trajectory realization t(p) in the Markov chain model P(ν), where ν is a zone and pεP(ν).

Non-fraudhood component 620 may receive fraud sets 540 and non-fraud modeled claims 650, and may calculate, for each fraud set 540, a non-fraudhood measure 660. Non-fraudhood measure 660 may include a measure of a likelihood of fraud set 540 being produced given non-fraud modeled claims 650 (e.g., in the absence of fraud). Non-fraudhood component 620 may provide non-fraudhood measures 660 to fraudhood ratio component 625.

In one example implementation, non-fraudhood component 620 may, in the Markov chain gravity model, calculate non-fraudhood measure 660 (F_{MCGM}) for a scenario involving a set (FRAUD) of beneficiaries as follows:

$${F}_{MCGM} = {\prod }_{p ∈ FRAUD} {π}_{MCGM} ( t ( p ) ) ,$$

where π_{MCGM}(t(p)) is a probability of a state trajectory realization t(p) in the Markov chain gravity model. The state trajectory realization probability may be given by a product of the transition probabilities of the state transitions that are followed in the state trajectory realization t(p) in the Markov chain gravity model G(ν), where ν is a zone and pεG(ν).

Fraudhood ratio component 625 may receive fraudhood measures 655 and non-fraudhood measures 660, and may calculate ratios 665 of fraudhood measures 655 and non-fraudhood measures 660. Fraudhood ratio component 625 may provide fraudhood ratios 665 to rank/threshold component 630 and collusion analysis component 635.

In one example implementation, consider first example fraud scenario 710 (FIG. 7) where a number of beneficiaries of one home provider (A) use another specific provider (B) in a remote zip code. It may be assumed that Y_{AX} is a number of beneficiaries who visit both provider A and provider B during an observation period, and that Y_{A} is a total number of beneficiaries who visit provider A. The beneficiaries who visit both provider A and provider B may be members of the set (FRAUD) of beneficiaries who are associated with possibly suspicious behavior. If fraudhood ratio component 625 assumes that π_{MCM}(i)=π, iεFRAUD, then fraudhood ratio component 625 may distribute Y_{AX} as a binomial random variable whose likelihood is

$${\prod }_{k = 1}^{z} {π}^{{Y}_{AXk}} ,$$

where Y_{AX2} may be Y_{A}−Y_{AX} and may be maximized as

$${\prod }_{k = 1}^{z} {( \frac{{Y}_{AKXk}}{{Y}_{A}} )}^{{Y}_{AXk}} .$$

In the absence of fraud, it may be assumed that π_{MCMNF} (i)=π₀, iεNo FRAUD, where fraudhood ratio component 625 may compute π₀ from the empirical gravity model. When a beneficiary visit is legitimate, a probability of visiting both provider A and provider B may depend on characteristics of the providers (e.g., their locations) and not on characteristics of the beneficiary. Fraudhood ratio 665 (FR) may be calculated as follows:

$$FR = {\prod }_{k = 1}^{z} {( \frac{{Y}_{AXk}}{{Y}_{A} {π}_{0}} )}^{{Y}_{AXk}} .$$

The term in parenthesis may represent a ratio of a number of suspicious visits observed to an expected number in the absence of fraud. Fraudhood ratios 665 may be calculated for the other examples of FIG. 7 in a similar manner. In general, fraudhood ratio 665 (FR) may be given by dividing a fraudhood measure (FR_{MCM}) by a non-fraudhood measure (FR_{MCMNF}):

$$FR = \frac{{F}_{MCM}}{{F}_{MCMNF}} .$$

In the Markov chain/gravity model, fraudhood ratio 665 (FR) may be given by:

$$FR = \frac{{F}_{MCM}}{{F}_{MCGM}} .$$

Rank/threshold component 630 may receive fraudhood ratios 665 and analysis parameters 550, and may produce ranked list 440 of suspected fraud cases based on fraudhood ratios and analysis parameters 550. Rank/threshold component 630 may also produce suspected fraud cases 450 based on fraudhood ratios and analysis parameters 550. In one example, suspected fraud cases 450 may include a ranked list of fraud sets 540 with associated fraudhood ratios 665 that satisfy (e.g., are above) a threshold indicating suspected fraud.

In one example implementation, fraudhood ratio 665 (FR) may provide an indication of a factor by which a realized potential fraud scenario is more probable (e.g., based on claims information 430) compared to how probable the scenario is expected to be (e.g., based on gravity modeling applied to claims information 430). The higher fraudhood ratio 665 becomes, the more likely the potential fraud scenario is an actual fraud scenario.

According to Wilkes' Theorem, −2 ln(FR) may be asymptotically distributed as a chi-square random variable with degrees of freedom (df) equal to a difference between the degrees of freedom of a numerator and a denominator. Rank/threshold component 630 may choose a threshold for fraudhood ratio 665 (FR) such that a p-value of −2 ln(FR) is smaller than a pre-specified value (e.g., 0.0001, 0.001, etc.). Rank/threshold component 630 may associate a potentially fraudulent scenario with such a p-value. The p-value is a dimensionless quantity, so rank/threshold component 630 may rank fraudulent entities (e.g., providers) by these values. The p-value has a probabilistic meaning (e.g., a probability that observed data is non-fraudulent), and rank/threshold component 630 may utilize the p-value to set a threshold for fraudulency. If fraudhood ratio 665 (FR) is greater than or equal to a specified threshold, rank/threshold component 630 may determine that a potential fraud scenario is a suspect for organized fraud. If fraudhood ratio 665 (FR) is less than the specified threshold, rank/threshold component 630 may retain fraudhood ratio 665 for the ranked fraud case list.

Collusion analysis component 635 may receive fraudhood ratios 665 and fraud sets 540, and may produce rings 460 of fraudulent providers based on fraudhood ratios 665 and fraud sets 540. In one example implementation, collusion analysis component 635 may utilize the identified single providers to create possible sets of colluding providers. For example, for each suspicious provider A, collusion analysis component 635 may tabulate the association rules with high coverage for provider A either as an antecedent or consequent (e.g., provider A is on either side of the “if . . . then . . . ” relationship). The association rules may provide a convenient way to count a number of beneficiaries in common between provider A and candidate colluders. A higher number of beneficiaries in common may indicate a stronger bond, and the number of beneficiaries in common may be tested via fraudhood ratio 665.

High confidence in an association rule may provide a way of showing how strong a bond is between provider A and a candidate ring member (e.g., provider B). If a rule (e.g., “if A then B”) has a high confidence, then many of provider A's beneficiaries may also visit provider B, so provider A may be a generator of suspicious claims when provider A is visited prior to provider B. If a rule (e.g., “if B then A”) has a high confidence, then provider B may owe most of his/her referrals to provider A. In both cases, collusion analysis component 635 may determine the bond between provider A and provider B to be strong. Another measure of the strength of a bond may include a time lag between visits to provider A and provider B. Time lag may include a number of days between treatments by the two providers, a number of other provider visits between the visits to the two providers, etc. In one example, a short time lag may be indicative of a strong bond.

Collusion analysis component 635 may utilize fraudhood ratio 665, for second example fraud scenario 720 (FIG. 7), to assess and rank associations between a previously-specified suspicious provider.

Fourth example fraud scenario 740 (FIG. 7) may depict a procedure, utilized by collusion analysis component 635, to create a potential set of colluders from a smaller set of previously-specified suspicious providers. Collusion analysis component 635 may analyze associations between remote providers (e.g., as in second example fraud scenario 720) to identify pairs or higher numbers of providers that are visited by beneficiaries more frequently than a gravity model would permit. The identified providers may constitute a set of suspicious providers (e.g., providers X₁, X₂, . . . X_{K}). Collusion analysis component 635 may identify providers (e.g., providers W₁, W₂, . . . , W_{L}) that may or may not be remote, are associated with any of the suspicious providers, and have respective numbers of beneficiary visits (Y_{XkWl}) with a high fraudhood ratio (FR_{XkWl}). The identified providers may be deemed colluders with one or more of providers X₁, X₂, . . . , X_{K}. A final set of colluders (e.g., providers X₁, X₂, X_{K}, W₁, W₂, . . . , W_{L}) may include a mixture of remote and non-remote providers, although at least two providers may be remote from each other. The final set of colluders may not be a ring of providers since there may be no guarantee that each provider is associated with all of the other providers. Fifth example fraud scenario 750 (FIG. 7) may be a special case of fourth example fraud scenario 740, but may include a single provider that is known to be suspicious.

Although FIG. 6 shows example functional components of fraudhood analysis component 520, in other implementations, fraudhood analysis component 520 may include fewer functional components, different functional components, differently arranged functional components, and/or additional functional components than those depicted in FIG. 6. Alternatively, or additionally, one or more functional components of fraudhood analysis component 520 may perform one or more tasks described as being performed by one or more other functional components of fraudhood analysis component 520.

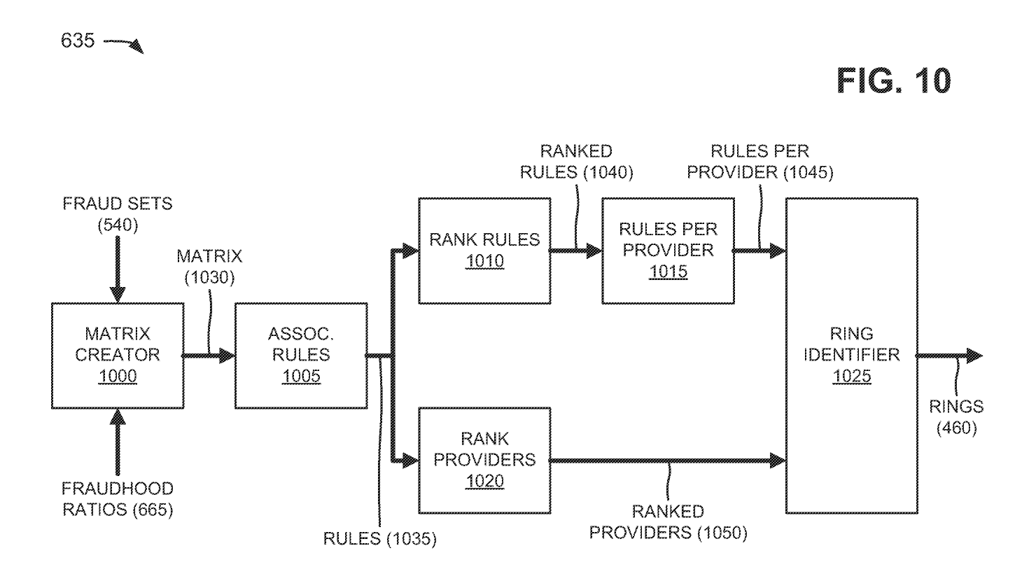

FIG. 10 is a diagram of example functional components of collusion analysis component 635. In one implementation, the functions described in connection with FIG. 10 may be performed by one or more components of device 300 (FIG. 3) or by one or more devices 300. As shown in FIG. 10, collusion analysis component 635 may include a matrix creator component 1000, an association rules component 1005, a rank rules component 1010, a rules per provider component 1015, a rank providers component 1020, and a ring identifier component 1025.

Matrix creator component 1000 may receive fraud sets 540 and fraudhood ratios 665. Matrix creator component 1000 may use a Markov model, fraud sets 540, and fraudhood ratios 665 to create a matrix 1030 of visits between providers. Matrix creator component 1000 may provide matrix 1030 to association rules component 1005.

Association rules component 1005 may receive matrix 1030, and may identify high coverage and high confidence association rules 1035 that link providers included in matrix 1030. Association rules component 1005 may provide association rules 1035 to rank rules component 1010 and rank providers component 1020.

Rank rules component 1010 may receive association rules 1035, and may rank association rules 1035 based on an interest measure with respect to fraud. Rank rules component 1010 may provide the ranked association rules 1040 to rules per provider component 1015.

Rules per provider component 1015 may receive ranked association rules 1040, and may count a number and an average interestingness of ranked association rules 1040, for each provider. Rules per provider component 1015 may provide the number and the average interestingness of rules 1040, for each provider, to ring identifier component 1025, as indicated by reference number 1045 (e.g., rules per provider information 1045).

Rank providers component 1020 may receive association rules 1035, and may rank providers identified in association rules 1035 based on a significance of a number of remote visits to the providers. Rank providers component 1020 may provide ranked providers 1050 to ring identifier component 1025.

Ring identifier component 1025 may receive rules per provider information 1045 and ranked providers 1050, and may identify rings 460 of fraudulent providers based on rules per provider information 1045 and ranked providers 1050. In one example, ring identifier component 1025 may identify rings 460 of fraudulent providers based on an association of ranked providers 1050 identified in rules per provider information 1045.

Although FIG. 10 shows example functional components of collusion analysis component 635, in other implementations, collusion analysis component 635 may include fewer functional components, different functional components, differently arranged functional components, and/or additional functional components than those depicted in FIG. 10. Alternatively, or additionally, one or more functional components of collusion analysis component 635 may perform one or more tasks described as being performed by one or more other functional components of collusion analysis component 635.

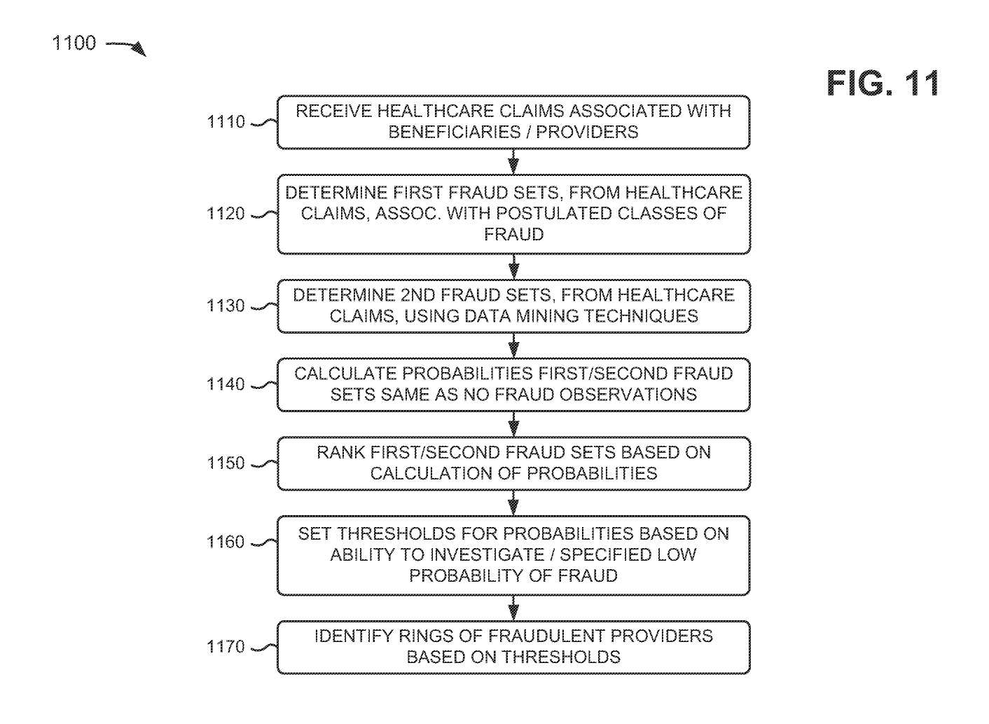

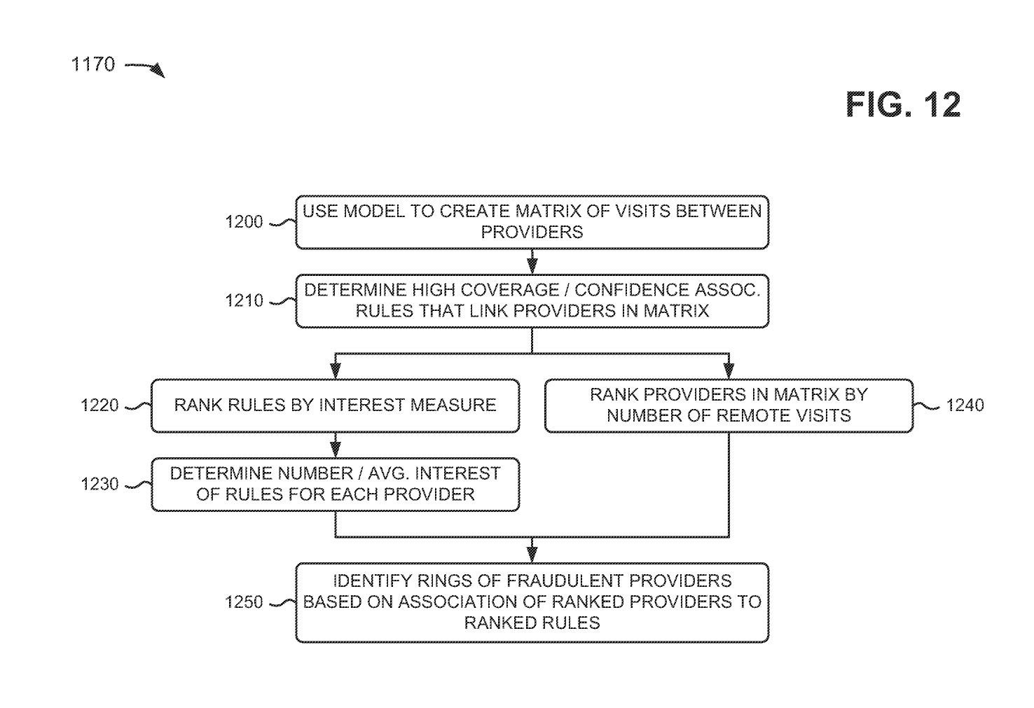

FIGS. 11 and 12 are flowcharts of an example process 1100 for detecting organized healthcare fraud. In one implementation, process 1100 may be performed by fraud detection system 230. Alternatively, or additionally, process 1100 may be performed by another device or a group of devices separate from or including fraud detection system 230.

As shown in FIG. 11, process 1100 may include receiving healthcare claims associated with beneficiaries and providers (block 1110), and determining first fraud sets, from the healthcare claims, associated with postulated classes of fraud (block 1120). For example, in an implementation described above in connection with FIG. 4, fraud detection system 230 may receive claims information 430, and may update claims information 430 in real-time. The updated claims information 430 may enable fraud detection system 230 to receive any changes in beneficiary and/or provider behavior that evolve over time. In one example, claims information 430 may include a set of claims 410 over a particular time period. Fraud detection system 230 may process claims information 430 to produce first fraud sets that may be members of postulated classes of organized healthcare fraud.

As further shown in FIG. 11, process 1100 may include determining second fraud sets, from the healthcare claims, using data mining techniques (block 1130), and calculating probabilities that the first and second fraud sets are the same as no fraud observations (block 1140). For example, in an implementation described above in connection with FIG. 4, fraud detection system 230 may perform data mining techniques on claims information 430 to produce second fraud sets from claims information 430. Fraud detection system 230 may calculate observations without fraud (or “no fraud” observations) using a gravitational model of aggregate numbers and loci associated with claims information 430. Fraud detection system 230 may calculate probabilities that the first and second fraud sets are statistically the same as the no fraud observations.

Returning to FIG. 11, process 1100 may include ranking the first and second fraud sets based on the calculated probabilities (block 1150), and setting thresholds for the probabilities based on an ability to investigate fraud and/or a specified low probability of fraud (block 1160). For example, in an implementation described above in connection with FIG. 4, fraud detection system 230 may rank the first and second fraud sets based on the calculated probabilities. Fraud detection system 230 may output (e.g., provide for display) and/or store a ranked list 440 of suspected fraud cases based on the ranking of the first and second fraud sets. Alternatively, or additionally, fraud detection system 230 may output (e.g., provide for display) and/or store suspected fraud cases 450 located in the first and second fraud sets. Fraud detection system 230 may set thresholds for the calculated probabilities based on either an ability to investigate fraud or on a specified low probability of non-fraudulence.

As further shown in FIG. 11, process 1100 may include identifying rings of fraudulent providers based on the thresholds (block 1170). For example, in an implementation described above in connection with FIG. 4, fraud detection system 230 may identify rings 460 of fraudulent providers based on the set thresholds and on the fraudulent providers' frequent associations with other fraudulent providers. Fraud detection system 230 may output (e.g., provide for display) and/or store rings 460 of fraudulent providers.

Process block 1170 may include the process blocks depicted in FIG. 12. As shown in FIG. 12, process block 1170 may include using a model to create a matrix of visits between providers (block 1200), determining high coverage and high confidence association rules that link providers in the matrix (block 1210), ranking the association rules by an interest measure (block 1220), and determining a number and an average interest of the association rules for each provider (block 1230). For example, in an implementation described above in connection with FIG. 10, matrix creator component 1000 may use a Markov model, fraud sets 540, and fraudhood ratios 665 to create matrix 1030 of visits between providers. Association rules component 1005 may identify high coverage and high confidence association rules 1035 that link providers included in matrix 1030. Rank rules component 1010 may rank association rules 1035 based on an interest measure with respect to fraud. Rules per provider component 1015 may count a number and an average interestingness of ranked association rules 1040, for each provider.

As further shown in FIG. 12, process block 1170 may include ranking the providers in the matrix by a number of remote visits (block 1240), and identifying rings of fraudulent providers based on an association of the ranked providers and the ranked association rules (block 1250). For example, in an implementation described above in connection with FIG. 10, rank providers component 1020 may rank providers identified in association rules 1035 based on a significance of a number of remote visits to the providers. Ring identifier component 1025 may identify rings 460 of fraudulent providers based on rules per provider information 1045 and ranked providers 1050. In one example, ring identifier component 1025 may identify rings 460 of fraudulent providers based on an association of ranked providers 1050 identified in rules per provider information 1045.

Systems and/or methods, described herein, may detect organized fraud in healthcare claims billing data. The systems and/or methods may detect organized healthcare fraud based on an assumption that it is highly improbable that a specific set of beneficiaries visit a same specific set of providers. The improbability may increase as a number of the beneficiaries and/or the providers increases and/or as geographic separation between the beneficiaries and the providers increases. The systems and/or methods may detect such unlikely scenarios in a set of claims, and may determine that the unlikely scenarios are a result of organized fraud.

The foregoing description of implementations provides illustration and description, but is not intended to be exhaustive or to limit the implementations to the precise form disclosed. Modifications and variations are possible in light of the above teachings or may be acquired from practice of the implementations.

For example, while series of blocks have been described with regard to FIGS. 11 and 12, the blocks and/or the order of the blocks may be modified in other implementations. Further, non-dependent blocks may be performed in parallel.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the implementations may be implemented as a “component” that performs one or more functions. This component may include hardware, such as a processor, an application-specific integrated circuit (ASIC), or a field-programmable gate array (FPGA), or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items and may be used interchangeably with ‘one or more. Where only one item is intended, the term “one” or similar language is used. Further, the phrase “based on” is intended to mean “based, at least in part, on” unless explicitly stated otherwise.

What is claimed is:

1. A method, comprising:
receiving, by one or more devices of a fraud detection system, information that identifies healthcare claims associated with providers and beneficiaries;
determining, by the one or more devices and based on the healthcare claims, first fraud sets associated with postulated classes of fraud;
determining, by the one or more devices and based on the healthcare claims, second fraud sets using a data mining technique;
calculating, by the one or more devices, probabilities that the first fraud sets and the second fraud sets are similar to no fraud observations;
ranking, by the one or more devices, the first fraud sets and the second fraud sets based on the calculated probabilities; and
outputting, by the one or more devices, a ranked list of suspected fraud cases, associated with the healthcare claims, based on the ranking of the first fraud sets and the second fraud sets.

2. The method of claim 1, further comprising:
setting thresholds for the calculated probabilities based on investigational ability and a specified low probability of fraud; and
identifying rings of fraudulent providers, associated with the healthcare claims, based on the thresholds.

3. The method of claim 2, further comprising:
outputting information identifying the rings of fraudulent providers.

4. The method of claim 2, where identifying the rings of the fraudulent providers includes:
using a model to create a matrix of visits between the providers associated with the healthcare claims;
determining association rules that link the providers in the matrix;
ranking the association rules based on a fraud interest measure;
ranking the providers in the matrix based on a number of remote visits; and
identifying the rings of the fraudulent providers based on a relationship between the ranked association rules and the ranked providers.

5. The method of claim 1, further comprising:
pre-processing the healthcare claims by grouping specialties, associated with the providers, into a plurality of categories.

6. The method of claim 1, where the suspected fraud cases are associated with beneficiaries that visit providers located remotely from each other.

7. The method of claim 1, further comprising:
outputting an unranked list of the suspected fraud cases associated with the healthcare claims.

8. A fraud detection system, comprising:
one or more processors to:
receive information that identifies healthcare claims associated with providers and beneficiaries,
determine, based on the healthcare claims, first fraud sets associated with postulated classes of fraud,
determine, based on the healthcare claims, second fraud sets using one or more data mining techniques,
calculate probabilities that the first fraud sets and the second fraud sets are similar to no fraud observations,
rank the first fraud sets and the second fraud sets based on the calculated probabilities, and
output or store a ranked list of suspected fraud cases, associated with the healthcare claims, based on the ranking of the first fraud sets and the second fraud sets.

9. The system of claim 8, where the one or more processors are further to:
set thresholds for the calculated probabilities based on investigational ability and a specified low probability of fraud, and
identify rings of fraudulent providers, associated with the healthcare claims, based on the thresholds.

10. The system of claim 9, where the one or more processors are further to:
output or store information identifying the rings of fraudulent providers.

11. The system of claim 9, where, when identifying the rings of the fraudulent providers, the one or more processors are further to:
use a model to create a matrix of visits between the providers associated with the healthcare claims,
determine association rules that link the providers in the matrix,
rank the association rules based on a fraud interest measure,
rank the providers in the matrix based on a number of remote visits, and
identify the rings of the fraudulent providers based on a relationship between the ranked association rules and the ranked providers.

12. The system of claim 8, where the one or more processors are further to:
pre-process the healthcare claims by grouping specialties, associated with the providers, into a plurality of categories.

13. The system of claim 8, where the suspected fraud cases are associated with beneficiaries that visit providers located remotely from each other.

14. The system of claim 8, where the one or more processors are further to:
output or store an unranked list of the suspected fraud cases associated with the healthcare claims.

15. One or more computer-readable media, comprising:
one or more instructions that, when executed by one or more processors of a fraud detection system, cause the one or more processors to:
receive information that identifies healthcare claims associated with providers and beneficiaries,
determine, based on the healthcare claims, first fraud sets associated with postulated classes of fraud,
determine, based on the healthcare claims, second fraud sets using one or more data mining techniques,
calculate probabilities that the first fraud sets and the second fraud sets are similar to no fraud observations,
rank the first fraud sets and the second fraud sets based on the calculated probabilities, and
output a ranked list of suspected fraud cases, associated with the healthcare claims, based on the ranking of the first fraud sets and the second fraud sets.

16. The media of claim 15, further comprising:
one or more instructions that, when executed by the one or more processors, cause the one or more processors to:
set thresholds for the calculated probabilities based on investigational ability and a specified low probability of fraud, and
identify rings of fraudulent providers, associated with the healthcare claims, based on the thresholds.

17. The media of claim 16, further comprising:
one or more instructions that, when executed by the one or more processors, cause the one or more processors to:
output information identifying the rings of fraudulent providers.

18. The media of claim 16, where the one or more instructions that cause the one or more processors to identify the rings of the fraudulent providers further include:
one or more instructions that, when executed by the one or more processors, cause the one or more processors to:
use a model to create a matrix of visits between the providers associated with the healthcare claims,
determine association rules that link the providers in the matrix,
rank the association rules based on a fraud interest measure,
rank the providers in the matrix based on a number of remote visits, and
identify the rings of the fraudulent providers based on a relationship between the ranked association rules and the ranked providers.

19. The media of claim 15, further comprising:
one or more instructions that, when executed by the one or more processors, cause the one or more processors to:
pre-process the healthcare claims by grouping specialties, associated with the providers, into a plurality of categories.

20. The media of claim 15, where the suspected fraud cases are associated with beneficiaries that visit providers located remotely from each other.
